(19) United States
(12) Patent Application Publication
(10) Pub. No.: US 2016/0092333 A1
(43) Pub. Date: Mar. 31, 2016

(54) Telemetry for Data

(71) Applicant: Microsoft Technology Licensing, LLC., Redmond, WA (US)

(72) Inventors: Zhen Liu, Tarrytown, NY (US); Chiu-Chun Bobby Mak, Beijing (CN); Jun He, Beijing (CN); Leida Chen, Beijing (CN)

(73) Assignee: Microsoft Technology Licensing, LLC., Redmond, WA (US)

(21) Appl. No.: 14/604,693

(22) Filed: Jan. 24, 2015

(30) Foreign Application Priority Data
Sep. 29, 2014 (CN) PCT/CN2014/087752

(51) Int. Cl. G06F 11/30

(52) U.S. Cl. CPC G06F 11/3003

(57) ABSTRACT

Embodiments are directed to a unified and extensible telemetry method together with a data telemetry model aimed at the data activities of a system. Information collected using the telemetry data model is analyzed using telemetry analytics to derive insights on data activities, through the analysis of single events and subsequent linear relationships between these events, as well as the more generally networked multi-dimensional relationships among the data activities. Such analysis can provide insights for system owners to understand past data activities, optimize current data activities, and predict future data activity demands and requirements.

### CROSS-REFERENCE TO RELATED APPLICATIONS

This application is a continuation of International Application No. PCT/CN2014/087752, which was filed on Sep. 29, 2014, the disclosure of which is hereby incorporated by reference herein in its entirety.

### BACKGROUND

There are many logging applications available that allow developers to troubleshoot and debug server or application behavior such as unexpected events and failures. These logging applications are typically designed for logging program actions on systems and interactions with other parties. The existing logging applications are usually not designed for tracking effects on data and on the dependencies between program actions on data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are directed to a unified and extensible telemetry data model for use by all components of a system. The information collected using the telemetry data model is analyzed using telemetry analytics tools to derive insights from data activities, through the analysis of single events and subsequent linear relationships between these events, as well as more generally networked multi-dimensional relationships among the data activities. Such analysis can provide insights for system owners to understand past data activities, optimize current data activities, and predict future data activity demands and requirements.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating the relationship between a user and multiple components in a system.

FIG. 2 is a block diagram illustrating one example of data collection flow in a system having a plurality of components.

FIG. 3 is a flowchart illustrating an example method for monitoring data activities in a system.

FIG. 4 illustrates an example of a suitable computing and networking environment for monitoring data activities in a system.

### DETAILED DESCRIPTION

System owners and admins may be interested in how end-users are accessing and using data in large systems with a large number of components. Telemetry data that reflects user behavior regarding data access and use across an entire system is not available using existing logging applications. Embodiments provide systems and method for effectively and efficiently collecting telemetry data from different components in a large system. By collecting meaningful and extensible information from each component system admins can analyze the collected data to gain insights on user behavior regarding how data is being accessed and used.

A unified telemetry collecting architecture may be used for large systems with many components. The telemetry data is collected using an extensible data model that can be applied to each component. A set of analytics based on the data model are used to provide insights for system admins to analyze past data use and access, optimize current data use and access, and predict future use and access demands.

Embodiments define and collect appropriate logs pertaining to relevant data activities and associated relationships. Using a well-defined telemetry data model during the collection of data, allows analysis of not only single events and data activities, but also the subsequent linear relationships of individual activities and multi-dimensional networks of activities.

Table 1 is an example telemetry data model used in one embodiment.

TABLE 1

| | VARIABLE |
|---|---|
| PARAMETER | TYPE |
| Id | string |
| TrackingId | string |
| UserType | Enum string |
| UserInfo | string |
| DateTime | datetime |
| EventName | string |
| EventType | Enum string |
| EventCategory | Enum string |
| EventChannel | Enum string |
| EventSource | string |
| EventTarget | string |
| EventResult | Enum string |
| EventResultDetail | string |
| EventResultSize | int |
| InputDataInfo | string |
| OutputDataInfo | string |
| EventCustomDetails | string |

A column of data is collected from users with the fields shown in Table 1. The Id field provides a unique identifier for a data transaction. The TrackingId field is used to correlate telemetry data from multiple events. The TrackingId may be, for example, a session identifier. The UserType field identifies the user type, such as an end-user or server. The UserInfo field holds user or server related information, such as, for example, identifiers, account number, or group number. The DateTime field is a timestamp, such as using an ISO-8601 format.

The EventName field is an operation name, such as an HTTP URL or method name. The EventType filed identifies whether the event is a request or response. The EventCategory field identifies the event category, such as read, create, update, or delete. The EventChannel field identifies the channel used, such as HTTP, HTTPS, TCP, UDP, or method call. The EventSource field lists a component name used to generate the event. The EventTarget field lists a target component for the event.

The EventResult field indicates whether the event was successful or failed. The EventResult field may include, for example, an HTTP status code. The EventResultDetail field provides a detailed description of the result, such as a root error cause. The EventResultSize field indicates the response size length, such as the number of kilobytes.

The InputDataInfo field may be used for input data entity information, such as a data entity name and data entity location. The OutputDataInfo field may be used for output data entity information, such as a data entity name and data entity location. The data entity name and data entity location may be separated by a colon (e.g., “Weather:HBase”), and multiple data entities may be separated by a pipe (e.g., ‘Weather:HBase|AQI:HBase’).

The EventCustomDetails field may include key-value pairs that contain custom business-related event detail information.

It will be understood that the telemetry data model illustrated in Table 1 is merely an example and is not intended to limit the amount or type of telemetry information that may be collected.

A well data telemetry model collects information about who called the data, when the data was called, where the data was called from, what query was used to call the data, how the data was accessed, etc. The data model collects information not only for single events and individual data activities, but also for subsequent linear relationships between these activities and multi-dimensional networks activities.

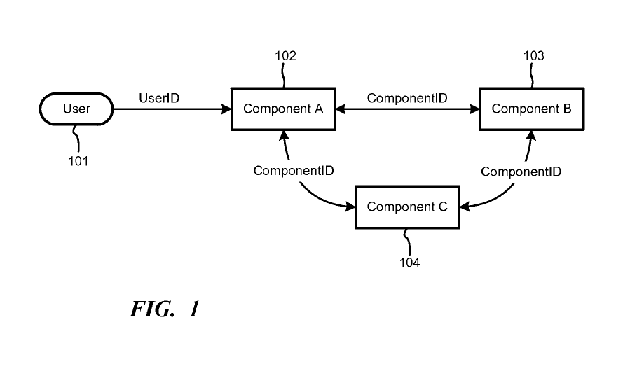

FIG. 1 is a block diagram illustrating the relationship between a user and multiple components in a system. The user 101 calls data from Component A 102. The data model captures information associated with that data call as one event. Component A 102 may call data from Component B 103 and/or from Component C 104. Components B 103 and Component C 104 may also interact directly. The data model also captures information associated with these events and identifies them using the respective component identifiers, for example. Components 102-104 may be servers, data bases, terminals, or any other node in a system.

Using the information captured by the data model, individual or point events associated with a particular user or component can be analyzed. Line relationships between two components or between a user and a component can be analyzed. For example, Component A 102 may call data from Component B 103 a number of times and that relationship may be analyzed using all of the data model information collected over a series of events. Additionally, a surface relationship among multiple components in the system can also be analyzed. For example, if Component A 102 calls data from Component B 103, which in turn calls data from Component C 104, then that multi-dimensional relationship can be analyzed and indirect connections between Component A 102 and Component C 104 may be studied.

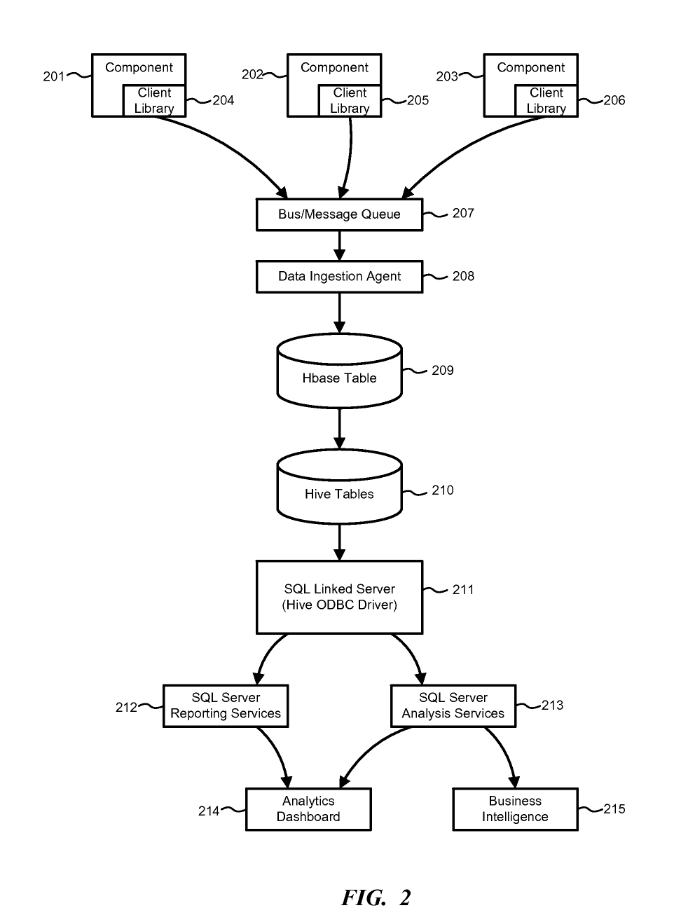

FIG. 2 is a block diagram illustrating one example of data collection flow in a system having a plurality of components 201-203. Each component 201-203 uses a client library 204-206 in their code to provide telemetry data based on a predefined data model, such as the example shown in Table 1. The client library on each component collects information for the data model and then asynchronously sends the information to a centralized bus 207.

A data ingestion agent 208 receives the information from bus 207 and dispatches the data to be store in a column-based storage 209, such as an Hbase table. The column based storage 209 is mapped to a data warehousing infrastructure 210, such as Hive tables.

Analytics and report generation tools make use of data stored in Hive tables 210. A SQL linked server 211 is connected to Hive tables 210 using an Open Database Connectivity (ODBC) API. SQL Server Reporting Services (SSRS) 212 provides tools and services for creating, deploying, and managing reports based on the data model information. System admins may customize the reporting functionality of SSRS Reporting Services to provide comprehensive reporting functionality for a variety of data sources, such as components 201-203. Additionally, SQL Server Analysis Services (SSAS) 213 may be used to deliver Online Analytical Processing (OLAP) and data mining functionality for business intelligence applications. For example, with SSAS the system admin may design, create, and manage multi-dimensional structures that contain data aggregated from other data sources, such as components 201-203. For data mining applications, SSAS 213 may be used by the system admin to design, create, and visualize data mining models using industry-standard data mining algorithms.

The system admin may receive the reports using an analytics dashboard 214 or a self-service business intelligence interface in any appropriate viewing format, such as tabular, graphical, or free-form reports.

Using the data collected from system components using the data model, the analytic tools may perform traditional performance and security analyses, such as measuring success rates, response times, and data volumes in the system.

More importantly, the data collected from system components using the data model can be used to analyze data activity, such as how the data is used and transformed. This may include, for example, activity on data entities, use frequency of data entities, data entity association, and data entity sequence. Additionally, data provenance can be tracked, such as mapping data provenance across the system as data moves from one component to another.

By providing information from distributed system components to a central data store using the data model, system admins can analyze how data sets move across the system. Additionally, transformations of the data sets as they move among system components can be analyzed. Analysis of the centrally stored data collection may provide insights as to how data changes from as it moves from one component to another so that the system admin can determine how and why data sets evolve.

Data compliance may also be measured, such as analyzing data access by confidential levels or channels, and/or analyzing data activity of personally identifiable information (PII), encrypted, or masked data. The timeliness of data can also be analyzed using the data model.

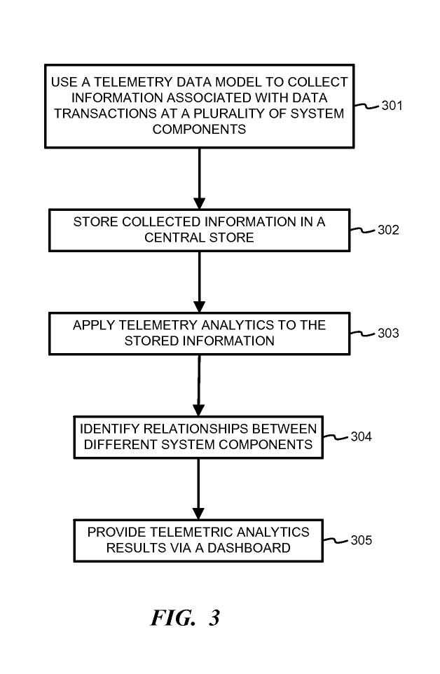

FIG. 3 is a flowchart illustrating an example method for monitoring data activities in a system. In step 301, a telemetry data model is used to collect information associated with data transactions at a plurality of components in the system. The telemetry data model may be stored in a client library on the system components, for example. In step 302, the collected information is stored in a central storage. In step 303, telemetry analytics are applied to the stored information.

In step 304, relationships between different system components are identified. The relationships are associated with transformations of data sets exchanged between the components. Linear relationships between different system components may be identified based upon related data activities. Multi-dimensional relationships among a network of three or more system components may be identified.

In step 305, the telemetry analytics results are provided to a system admin via a dashboard.

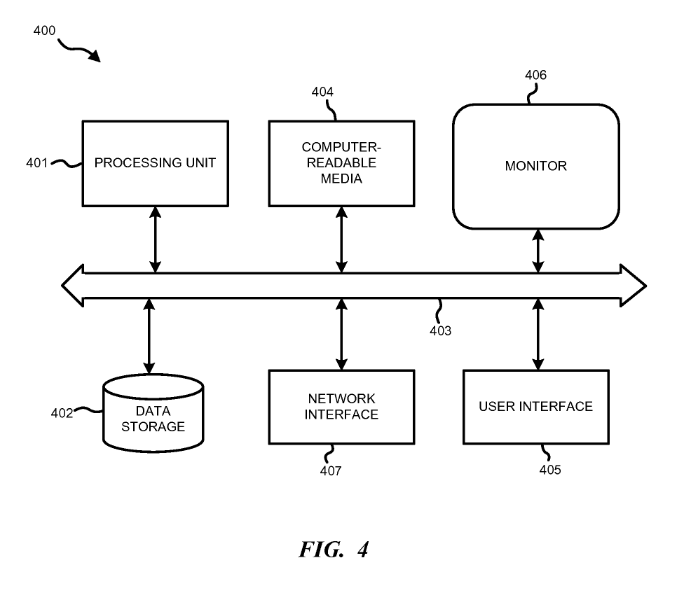

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Computing environment 400 may represent a component that collects information about data activities and/or a data store or server that stores or analyzes the stored data activity information.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 400. Components may include, but are not limited to, various hardware components, such as processing unit 401, data storage 402, such as a system memory, and system bus 403 that couples various system components including the data storage 402 to the processing unit 401. The system bus 403 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 400 typically includes a variety of computer-readable media 404. Computer-readable media 404 may be any available media that can be accessed by the computer 400 and includes both volatile and nonvolatile media, and removable and non-removable media, but excludes propagated signals. By way of example, and not limitation, computer-readable media 404 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 400. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 402 includes computer storage media in the form of volatile and/or nonvolatile memory such as read only memory (ROM) and random access memory (RAM). A basic input/output system (BIOS), containing the basic routines that help to transfer information between elements within computer 400, such as during start-up, is typically stored in ROM. RAM typically contains data and/or program modules that are immediately accessible to and/or presently being operated on by processing unit 401. By way of example, and not limitation, data storage 402 holds an operating system, application programs, and other program modules and program data.

Data storage 402 may also include other removable/non-removable, volatile/nonvolatile computer storage media. By way of example only, data storage 402 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 4, provide storage of computer-readable instructions, data structures, program modules and other data for the computer 400.

A user may enter commands and information through a user interface 405 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 401 through a user input interface 405 that is coupled to the system bus 403, but may be connected by other interface and bus structures, such as a parallel port, game port or a universal serial bus (USB). A monitor 406 or other type of display device is also connected to the system bus 403 via an interface, such as a video interface. The monitor 406 may also be integrated with a touch-screen panel or the like. Note that the monitor and/or touch screen panel can be physically coupled to a housing in which the computing device 400 is incorporated, such as in a tablet-type personal computer. In addition, computers such as the computing device 400 may also include other peripheral output devices such as speakers and printer, which may be connected through an output peripheral interface or the like.

The computer 400 may operate in a networked or cloud-computing environment using logical connections 407 to one or more remote devices, such as a remote computer. The remote computer may be a personal computer, a server, a router, a network PC, a peer device or other common network node, and typically includes many or all of the elements described above relative to the computer 400. The logical connections depicted in FIG. 4 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 400 may be connected to a public or private network through a network interface or adapter 407. In some embodiments, a modem or other means for establishing communications over the network. The modem, which may be internal or external, may be connected to the system bus 403 via the network interface 407 or other appropriate mechanism. A wireless networking component such as comprising an interface and antenna may be coupled through a suitable device such as an access point or peer computer to a network. In a networked environment, program modules depicted relative to the computer 400, or portions thereof, may be stored in the remote memory storage device. It may be appreciated that the network connections shown are exemplary and other means of establishing a communications link between the computers may be used.

A method for monitoring data activities in a system comprises using a telemetry data model to collect information associated with data transactions at a plurality of components in the system, storing the information in a central storage, and applying telemetry analytics to the stored information. The telemetry data model may be stored in a client library on the system components.

The method may further comprise identifying, using the telemetry analytics, linear relationships between different system components based upon related data activities. The method may further comprise identifying, using the telemetry analytics, multi-dimensional relationships among a network of three or more system components. The method may further comprise identifying relationships between different system components, the relationships associated with transformations of data sets exchanged between the components.

The method may further comprise providing telemetry analytics results via a dashboard.

A system for analyzing data activities comprises a central data store receiving data activity information from a plurality of components, the data activity information collected using a telemetry data model, and a server coupled to the central data store, the server applying telemetry analytics applications to the data activity information to analyze data events. The system may further comprise a dashboard coupled to the server for providing telemetry analytics results to a user.

The telemetry analytics may be configured to extract insights associated with a single data activity event. The telemetry analytics may further be configured to identify linear relationships between components and data activities and/or to identify multi-dimensional networks among three or more components based on the data activities.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for monitoring data activities in a system, comprising:
using a telemetry data model to collect information associated with data transactions at a plurality of components in the system;
storing the information in a central storage; and
applying telemetry analytics to the stored information.

2. The method of claim 1, further comprising:
identifying, using the telemetry analytics, linear relationships between different system components based upon related data activities.

3. The method of claim 1, further comprising:
identifying, using the telemetry analytics, multi-dimensional relationships among a network of three or more system components.

4. The method of claim 1, further comprising:
identifying relationships between different system components, the relationships associated with transformations of data sets exchanged between the components.

5. The method of claim 1, wherein the telemetry data model is stored in a client library on the system components.

6. The method of claim 1, further comprising:
providing telemetry analytics results via a dashboard.

7. A system for analyzing data activities, comprising:
a central data store receiving data activity information from a plurality of components, the data activity information collected using a telemetry data model; and
a server coupled to the central data store, the server applying telemetry analytics applications to the data activity information to analyze data events.

8. The system of claim 7, further comprising:
a dashboard coupled to the server for providing telemetry analytics results to a user.

9. The system of claim 7, wherein the telemetry analytics are configured to extract insights associated with a single data activity event.

10. The system of claim 7, wherein the telemetry analytics are configured to identify linear relationships between components and data activities.

11. The system of claim 7, wherein the telemetry analytics are configured to identify multi-dimensional networks among three or more components based on the data activities.
